(19) United States
(12) Patent Application Publication
(10) Pub. No.: US 2006/0018070 A1
(43) Pub. Date: Jan. 26, 2006

(54) Diode chip for ESD/EOS protection for multiple element device

(75) Inventor: Icko Eric Timothy Iben, Santa Clara, CA (US)

Correspondence Address: Zilka-Kotab, PC, P.O. BOX 721120, SAN JOSE, CA, 95172-1120, US

(73) Assignee: INTERNATIONAL BUSINESS MACHINES CORPORATION

(21) Appl. No.: 10/897,275

(22) Filed: Jul. 21, 2004

(51) Int. Cl. H02H 3/20

(52) U.S. Cl. 361/91.1

(57) ABSTRACT

A mechanism for protecting an electronic component from electrostatic discharge (ESD) and electrical overstress (EOS) damage. The protective device includes a substrate that is adapted for coupling to a cable and/or another device, e.g., a card, the electronic component (a multi-element magnetic tape head or disk head, etc.), etc. Multiple sets of crossed diodes are coupled to the substrate. Contact leads are coupled to the substrate, and are in electrical communication with the sets of diodes. The diode(s) provide current shunting in the event of an ESD, EOS or other power surge, thereby protecting the electronic component from damage.

### FIELD OF THE INVENTION

The present invention relates to a device for protection from electrostatic discharge and electrical overstress, and more particularly, this invention relates to using diodes for protecting an electronic device from electrostatic discharge and electrical overstress.

### BACKGROUND OF THE INVENTION

Magnetic head-based systems have been widely accepted in the computer industry as a cost-effective form of data storage. In a magnetic tape drive system, a magnetic tape containing a multiplicity of laterally positioned data tracks that extend along the length of the tape is drawn across a magnetic read/write transducer, referred to as a magnetic tape head. The magnetic tape heads can record and read data along the length of the magnetic tape surface as relative movement occurs between the heads and the tape. Because magnetic tape is a flexible media, its lateral position fluctuates as the tape is pulled at high speeds across the tape head. In order to maintain alignment of the read sensors or writing transducers along the tracsk, the tape head is moved (actuated) laterally to follow the tape fluctuations as the high speed lateral response, termed actuation, is better achieved with lighter tape heads.

In a magnetic disk drive system, a magnetic recording medium in the form of a disk rotates at high speed while a magnetic head “flies” slightly above the surface of the rotating disk. The magnetic disk is rotated by means of a spindle drive motor. The magnetic head is attached to or formed integrally with a “slider” which is suspended over the disk on a spring-loaded support arm known as the actuator arm. As the magnetic disk rotates at operating speed, the moving air generated by the rotating disk in conjunction with the physical design of the slider lifts the magnetic head, allowing it to glide or “fly” slightly above and over the disk surface on a cushion of air, referred to as an air bearing. The flying height of the magnetic head over the disk surface is typically only a few tens of nanometers or less and is primarily a function of disk rotation, the aerodynamic properties of the slider assembly and the force exerted by the spring-loaded actuator arm.

Magnetoresistive (MR) sensors are particularly useful as read elements in magnetic heads, used in the data storage industry for high data recording densities. Two examples of MR materials used in the storage industry are anisotropic magnetoresistive (AMR) and giant magnetoresistive (GMR). MR and GMR sensors are deposited as small and thin multi-layered sheet resistors on a structural substrate. The sheet resistors can be coupled to external devices by contact to metal pads which are electrically connected to the sheet resistors. MR sensors provide a high output signal which is not directly related to the head velocity as in the case of inductive read heads.

To achieve the high areal densities required by the data storage industry, the sensors are made with commensurately small dimensions. The smaller the dimensions, the more sensitive the thin sheet resistors become to damage from spurious current or voltage spike.

A major problem that is encountered during manufacturing, handling and use of MR sheet resistors as magnetic recording transducers is the buildup of electrostatic charges on the various elements of a head or other objects which come into contact with the sensors, particularly sensors of the thin film type, and the accompanying spurious discharge of the static electricity thus generated. Static charges may be externally produced and accumulate on instruments used by persons performing head manufacturing or testing function. These static charges may be discharged through the head causing excessive heating of the sensitive sensors which result in physical or magnetic damage to the sensors.

As described above, when a head is exposed to voltage or current inputs which are larger than that intended under normal operating conditions, the sensor and other parts of the head may be damaged. This sensitivity to electrical damage is particularly severe for MR read sensors because of their relatively small physical size. For example, an MR sensor used for high recording densities for magnetic tape media (order of 25 Mbytes/cm²) are patterned as resistive sheets of MR and accompanying materials, and will have a combined thickness for the sensor sheets on the order of 500 Angstroms (Å) with a width of 1 to 10 microns (μm) and a height on the order of 1 μm. Sensors used in extant disk drives are even smaller. Discharge currents of tens of milliamps through such a small resistor can cause severe damage or complete destruction of the MR sensor. The nature of the damage which may be experienced by an MR sensor varies significantly, including complete destruction of the sensor via melting and evaporation, oxidation of materials at the air bearing surface (ABS), generation of shorts via electrical breakdown, and milder forms of magnetic or physical damage in which the head performance may be degraded. Short time current or voltage pulses which cause extensive physical damage to a sensor are termed electrostatic discharge (ESD) pulses. Short time pulses which do not result in noticeable physical damage (resistance changes), but which alter the magnetic response or stability of the sensors due to excessive heating are termed electrical overstress (EOS) pulses.

While a disk head is comprised of a single MR element, modern tape heads have multiple MR elements, on the order of 8 to 32, or even more, all of which must be fully functional. The large number of MR sensors in a tape drive and the requirement that all are functional, makes ESD loss due to a single element very expensive as the entire head must then be scrapped. Testing during manufacturing is important in order to eliminate damaged components early in the process to minimize cost by avoiding processing of damaged parts.

Prior solutions to ESD and EOS protection can be summarized into two types of approaches: 1) by using diode(s) and 2) by shorting out the sensor element. Both of these approaches have significant disadvantages. Electrically shorting out the MR sensors, by shorting the two ends of the sensor which connect to external devices, provides the best possible ESD protection. The problem with this technique is that the head is no longer functional while the short is applied. Once the short is removed, for testing or use, the sensors are no longer protected.

In the diode approach, the diode is intended to remain in parallel with the sensor element during normal operation of the disk (or tape) drive. Potential problems which the diode approach are: 1) drainage of current under normal operation degrading the sensor performance, 2) excessive weight of the diode package affecting mechanical motion of the tape head, 3) excessive cost of adding a multiplicity of diodes, 4) physically being able to fit a multiplicity of diodes onto a cable, and 5) space constraints within a small tape drive.

For example, one method used in the hard disk drive industry is to use a diode package containing a pair of diodes connected in parallel across the MR element, each diode pointing in the opposite forward bias direction, (crossed diodes) to protect the MR device. This has not been implemented in tape drives due to cost and size issues. Particularly, since modern tape heads have multiple read elements, it can be expensive to add packages containing individual diodes or pairs of diodes for each element, particularly when the head and cable are scrapped during the testing phase. While mounting diodes on a single slider may be cost effective, the sheer number of diodes required for a modern tape head can add significant cost to the head.

While diode protection used for disk drives uses a pair of crossed diodes, the voltages applied in to the MR elements in tape heads (e.g., >0.6 V) would cause a single diode to shunt too much current, resulting in degraded performance. Furthermore, the added weight of many diodes or chips on the cable will affect the dynamics of the head actuation, potentially degrading its track following performance. Another constraint is the physical space within an extant tape drive requires extremely small components.

A need therefore exists for providing ESD and EOS protection for a multiplicity of read and/or write head assemblies which has a low cost, is small enough not to affect the dynamics of the head during operation, which fits into the tight spaces within a tape or disk drive, and which allows for the higher voltages used in normal tape drive operation.

### SUMMARY OF THE INVENTION

The present invention provides a mechanism for protecting an electronic component from ESD/EOS damage. The protective device includes a substrate that is adapted for coupling to a cable and/or another device, e.g., a card, the electronic component (a multi-element magnetic tape head or disk head, etc.), etc. Multiple sets of crossed diodes are coupled to the substrate. Contact leads are coupled to the substrate, and are in electrical communication with the sets of diodes. The diode(s) provide current shunting in the event of an ESD shock or other power surge, thereby protecting the electronic component from damage.

The substrate may be flexible to reduce stress on any cables to which it is attached. The substrate may also be substantially resilient for ease of manufacture and/or for durability to extend its useful life.

In one embodiment, the device includes two diodes, each connected in parallel with the device to be protected from damage but in reverse polarity, (crossed diodes), to protect the electronic component from damage, regardless of the electrical polarity of EOS/ESD current pulses. To adjust the voltage limit of the diode array, multiple diodes can be aligned in series in each direction. Preferably, the diodes have a response time of less than about 20 nanoseconds. The diodes can be coupled directly to the substrate or formed thereon. The diodes may also be contained in a chip that is coupled to the substrate.

The choice in the number of diodes connected in series is dependent upon the voltage range used in testing and operation. For example, if the device to be protected has a 50 Ω resistance and the maximum testing or operational current is 12 mA (or 0.6 V). In order to not affect the sensor performance, the series of diodes should not conduct substantially below the forward bias “turn on” voltage of 0.6 V. Conventional pn or np diodes conduct at ˜0.6 V, so two diodes connected in series would not conduct substantially below a total forward bias voltage of ˜1.2 V (2×0.6 V). For example, for a maximum test/operation current of 12 mA, only 0.3 V would, be across each diode, resulting in very little current being shunted through the diodes. Adding more diodes in series than two would not be advisable due to cost, reliability, as well as jeopardizing the protective sensitivity of the diode circuit. For ESD/EOS protection, the lower the turn on voltage the better, favoring the fewer number of diodes. In tape drive operation, current only flows through the sensor in one direction. Thus, in this example, three diodes would be optimal, two in the forward direction and one in the reverse direction.

In one embodiment, the substrate is a chip, the chip being coupled to the device or the cable. Preferably, the substrate is a flip chip. Anisotropic conductive film (ACF) can be used to couple the flip chip to the head or cable. The diodes in the chip can be vertically or horizontally aligned with respect to a longitudinal axis of the cable or head.

In another embodiment, the diodes are formed on a chip, the chip being coupled to the substrate.

The protective device can further include resistive elements in electrical communication with a ground and the sets of diodes to discharge any common mode charge built up on the leads.

According to a preferred embodiment, the protective device includes a chip adapted for coupling to a cable, the chip having multiple sets of crossed diodes, each set of diodes being for providing ESD protection to an individual component of an electronic device coupled to the cable. For example, each set of crossed diodes can be coupled to an individual element of the tape head. The chip has contact leads in electrical communication with the sets of diodes, the electrical leads being coupleable to conductors of the cable. Again, anisotropic conductive film (ACF) is preferably used to couple the chip to the cable. This embodiment is particularly useful for protecting a tape head containing a large multiplicity of components, where the components of the tape head to be protected are selected from a group consisting of data readers, data writers, and servo readers.

A tape drive system according to one embodiment includes a magnetic “tape” head containing a multiplicity of sensors capable of detecting magnetic transitions written onto a magnetic recording tape; a drive mechanism for passing a magnetic recording tape over the magnetic tape head; a controller electrically coupled to the magnetic tape head for controlling a voltage of the conducting circuit of the magnetic tape head; a cable coupling the controller to the magnetic tape head; and a diode chip coupled to the cable, the diode chip having multiple sets of crossed diode groups forming a set of crossed diode groups. A set of crossed diode groups is present for each sensor of the magnetic tape head which requires protection. a set of crossed diodes includes two groups of diode(s), where a group of diodes is one or more diodes connected in series and aligned in the same forward bias direction. The two groups of diodes in a set of crossed diode groups are electrically connected in parallel with one another but in opposite forward bias directions. The set of crossed diode groups are connected in parallel with the sensor which they are protecting from ESD/EOS damage. The number of diodes in each group forming the pair of crossed diode groups (set) need not be the same.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial side view of a tape head in use.

FIG. 2 is a perspective view of a single module of a tape head.

FIG. 3 is a circuit diagram showing two sets of crossed diode groups applied to a single MR sensor.

FIG. 4A is a top view, not to scale, of a diode chip according to one embodiment.

FIG. 4B is a top view, not to scale, of a diode chip according to an embodiment.

FIG. 5 is a simplified cross sectional view, not to scale, of anisotropic conductive film bonding.

FIG. 6 is a top view of one layer of a multilayered cable containing conductive elements.

FIG. 7 is a top view of a conductor layer of a multilayered cable.

FIG. 8 is a top view of a cable prior to coupling of diode chips thereto.

FIG. 9 is a top view of a cable after coupling of diode chips thereto.

FIG. 10 is a top view depicting a multiple crossed diode chip according to one embodiment.

FIG. 11 is a partial detailed view of the chip of FIG. 10 taken from Circle 11 of FIG. 10.

FIG. 12 is a circuit diagram of a horizontally aligned multiple crossed diode chip according to one embodiment.

FIG. 13 is a circuit diagram of a vertically aligned multiple crossed diode chip according to one embodiment.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present description discloses a protective device for protecting components of an electronic device from ESD and EOS damage. Although the invention is described as embodied for use with a magnetic tape storage system, the invention also applies to other electronic devices, including magnetic recording systems and applications using a sensor to detect a magnetic field.

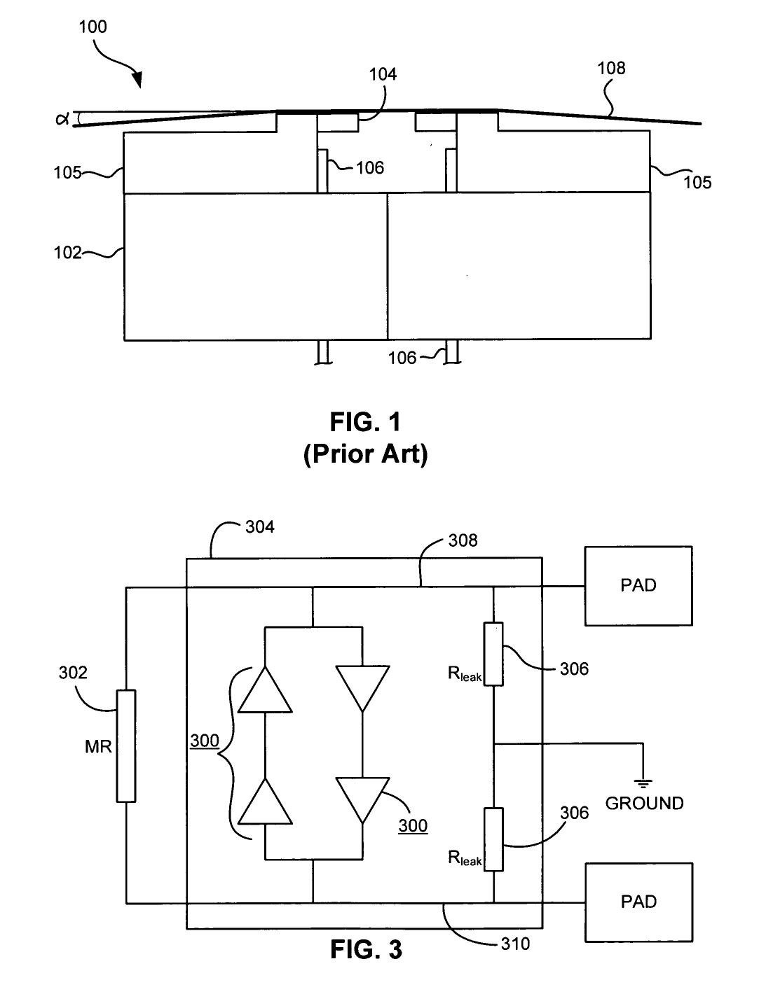

Prior art FIG. 1 illustrates a tape head in use. As shown, FIG. 1 illustrates a completed head for a read-while-write bidirectional linear tape drive. “Read-while-write” means that the read element follows behind the write element. This arrangement allows the data just written by the write element to be immediately checked for accuracy and true recording by the trailing read element. Specifically, in FIG. 1, a tape head 100 comprising two modules 105 are mounted on a ceramic substrate 102 which are, in turn, adhesively or otherwise physically coupled. Each of the modules 105 includes several read sensors and/or write transducers electrically coupled to pads (not shown) for subsequent attachment to external electronic devices. Closures 104 are coupled to the modules 105 to support the tape and protect the read/write elements from wear by the tape. Conductive wires in cables 106 are fixedly and electrically coupled to the pads. The tape 108 wraps over the modules 105 at a predetermined wrap angle α.

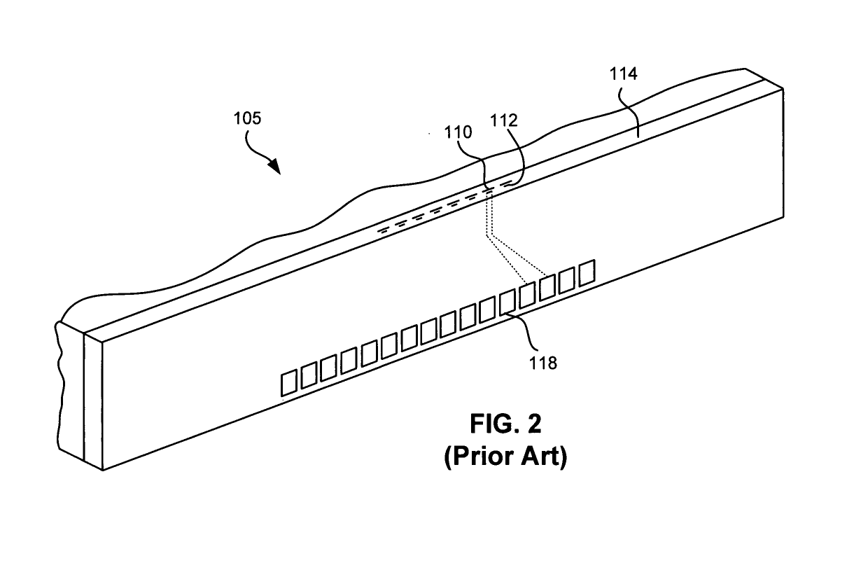

Prior art FIG. 2 illustrates a tape module 105 formed with read and write elements 110, 112 exposed on a tape bearing surface 114 of the module 105. The elements 110, 112 are coupled to pads 118 which are in turn attached to cables 106 prior to installation in a drive.

According to one embodiment, a semiconductor chip provides diode protection utilizing a multiplicity of sets of crossed diode groups to protect against excessive current or voltage pulses which might inadvertently be applied across any one of a multiplicity of MR or other devices which would be sensitive to such pulses. The chip incorporates one-to-N diodes in series in each group, the groups being oriented in opposite directions for each device to be protected. Also, as an option, elements with a high (relative to the MR sensor) resistance (Rₗₑₐₖ) can be connected to each end of the MR sensor and to ground to discharge any common mode charge built up on the leads.

A diode functions as the electronic version of a one-way valve. By restricting the direction of movement of charge carriers, it allows an electric current to flow in one direction when forward biased, but blocks it in the opposite direction when reverse biased. A forward biased diode's current-voltage, or I-V, characteristic can be approximated by two regions of operation. Below a certain difference in potential between the two leads, the diode can be thought of as an open (non-conductive) circuit. As the potential difference is increased, at some stage the diode will become conductive and allow current to flow, at which point it can be thought of as a connection with zero (or at least very low) resistance. In the conductive state, the diode is “turned on”. The need for crossed diodes for ESD/EOS protection is because the current voltage surges from such events have random polarity and can pass in either direction.

Diodes in general turn on at about 0.6 to 0.8 V when forward biased. However, the invention is not to be limited to these particular voltages, and may have higher or lower voltage characteristics. Preferred diodes have a fast response time. Preferably, the response time is less than about 20 nanoseconds, and ideally less than about 10, and even less than about 1 to 5, nanoseconds, to shunt the fast current pulse typical during an ESD event.

The diode chip includes a substrate to which pairs of crossed diode groups are mounted, one pair of diode groups (i.e., one set) being provided for each element of the head to which the device is attached which requires protection. For instance, a disk head has only one reader, so one set of diodes would be provided. A tape head having eight read sensors would be coupled to eight sets (pairs) of crossed diode groups, and so on. In general, writers require orders of magnitude higher currents to be damaged and to not require protection. A diode chip containing N diodes in series for a given direction limits the voltage across the read element to N times the diode limit voltage in that direction, which is typically around about 0.6 to 0.8 volts for each individual diode. In the event of an ESD or EOS, the diode connected to the lead carrying the excess current will shunt the current across the diode to the other lead, where the bulk of the current is passed through the shunt rather than through the head. This reduces the probability of damage to the read element. The use of crossed diodes provides protection against current voltage or pulses of either positive or negative polarity across the sensor to be protected.

FIG. 3 shows one set (pair) of crossed diode groups 300 applied to a single MR element 302. As shown, the diodes are deposited on a silicon chip 304. Resistive elements (Rₗₑₐₖ) 306 can also be deposited in the chip. The resistive elements 306 serve to dissipate common mode charge built onto the leads 308, 310 of the MR element 302.

The invention preferably incorporates two groups of one-to-N diodes in series in opposing directions per set of diodes, with multiple sets of diodes being present on a single diode chip. The number of diodes selected will depend on the application in which it is being used. In general, it is desirable to choose the minimum number of diodes needed to ensure that under normal operating voltages applied to the sensor, the bypass current flowing through the diodes will have a minimal effect on the functioning of the device but will shunt substantial current and voltages well below the damage threshold for the sensor being protected. Particularly, the number (N) of diodes is selected so that under normal operating voltages (Vnormal) applied across the MR device, the resistance of N diodes in series, each with a voltage of Vnormal/N, will be substantially higher than the sensor resistance so as not to substantially influence the device performance. While the hard disk drive (HDD) industry has used crossed diodes to protect the single MR devices used in computers, the tape industry has not due to several factors. First, because of the multitude of sensors used in tape products (8 or 16 or more), physically locating the number of diodes using single diode elements is very costly. Furthermore, the conventional approach has been to use standard gull wing packaging to hold diodes. Gull wing packages are large and can add substantial weight to the head, which can affect the critical actuation performance of the head. Furthermore, the pitch (lead-to-lead separation) of the electrical leads on a gull wing package is large with minimum separations of 5 microns or more. With large numbers of elements in a tape head, lead-to-lead separations of under 100 microns are common. By incorporating many diodes in a single chip, it is possible to mount enough diodes to protect a large number of heads with a single chip. Also, for each MR, the HDD industry uses a set of crossed diode groups with a single diode in each group. Because of the larger voltages applied to MR elements used in tape heads under normal operating conditions, a single diode would shunt substantial amounts of current, degrading the performance of the MR sensor. N diodes in series, though will drop the voltage across a diode by N. Two diodes in series is sufficient for many modern tape drive systems. Also, HDDs do not incorporate a high impedance leakage resistance to dissipate any common mode charges built up on a lead which if discharged by a sudden contact to a reader might result in a discharge which is too fast for the diodes to respond to, resulting in sensor damage.

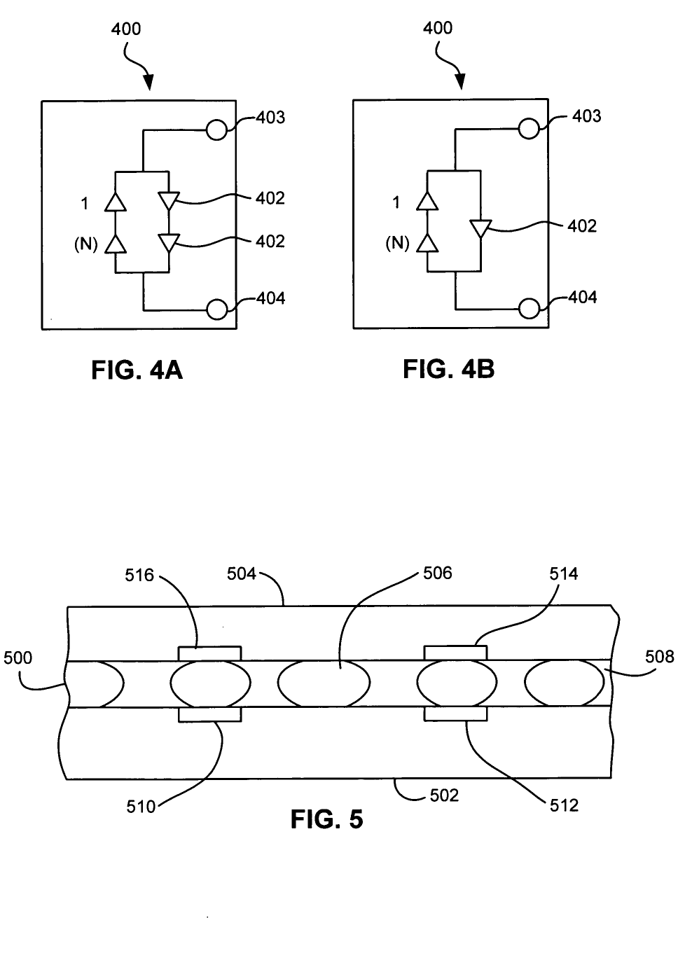

If the particular operating voltage is higher than 0.6 V, say 0.8 V, then a single forward biased diode will be turned on under normal operating conditions, shunting a substantial amount of current from the sensor and degrading the sensor performance. To solve this problem, multiple diodes connected in series may be used in each group of a set of crossed diode groups to increase the total voltage limit for turning on a diode group. FIG. 4A illustrates a chip 400 having multiple diodes 402 coupled to contact pads 403, 404. The number of diodes 402 in series increases the total voltage limit to the sum of the voltage limits of the diodes 402. For example, if two 0.6 V diodes are directed in the forward bias direction, (relative to the sensor operation polarity), then the total voltage limit is doubled to 1.2 V. If the operating current is 1.5 V, at least three 0.6 V diodes in the forward bias polarity direction are required.

As is the case in most MR sensors, they function properly only when biased in one direction. In this figure forward bias polarity is between the contact pads 403, 404. Thus, in the case just described where three diodes in series are required, for biasing in the functional direction, only one diode is required for the reverse biasing direction. FIG. 4B depicts this with diodes 402 in series for the functional bias direction and one in the reverse. This embodiment reduces the processing requirements for fabricating the diode chip 400.

As another example, a single diode might have a relatively low resistance for voltages of ˜0.5V at, say ˜500 Ω. For a 50 Ω sensor biased at 0.5V, the single diode would shunt ˜10% of the supplied current, degrading the response of the sensor by that amount. With two diodes in series, the voltage across each diode would only be 0.25V, which is substantially below the turn on voltage of a single diode. In this case, the diode resistance would be relatively high, say 2500 Ω, or 5000 Ω for the two diodes in series. 5000 Ω connected in parallel with the 50 Ω sensor, then would only shunt 1% of the current and would have a minor effect on the sensor's performance. Thus for two diodes in series, the diodes will not shunt a significant amount of voltage for voltages across the sensor of <˜0.5V. For high current ESD pulses (several volts), the diodes will shunt the bulk of the current restricting the flow of current through the MR sensor to a nondestructive amount. The dual directionality of the diode “set” is to protect against ESD damage in either polarity.

A resistor leakage resistor can be deposited onto the chip with a material having the appropriate thickness and length to result in the desired leakage resistance value (Rₗₑₐₖ). A preferred range of Rₗₑₐₖ would be between 10 k and 100 k ohms, but could be larger or smaller depending on the requirements for the particular sensor (reader) and detection electronics. Note that one or more leakage resistors can be added for reach set of diodes. For example, each set of crossed diodes has two contact locations, one for each end of the set of crossed diodes and where each contact location connects to a common ground for all diode sets through an individual resistor having the desired leakage resistance. Also, one or more leakage resistors can be provided for sets of crossed diodes collectively.

One form of integrated chip (IC) package containing diodes is a gull wing package. Gull wing IC chip packages are made by dicing silicon wafers containing diodes and mounting the diodes on a separate package containing external leads. The contact to the cable lead is made using solder. In IC chips using gull wing packaging, the minimum lead-to-lead separation (pitch) is limited to ˜500 microns.

A preferred form of the diode chip is as a “flip chip” as opposed to a gull wing type chip, though gull wing type chips can in principal be used. A flip chip is a type of integrated chip (IC) chip mounting which does not require additional wire leads. Instead the final wafer processing step deposits electrical pads on the chip. After cutting the wafer into individual chips, the “flip chip” can then be mounted upside down in/on the final electronic circuit which uses the chip components (eg cable with MR sensors). One means of electrically connecting the flip chip to the cable is to deposit solder beads on the chip pads. The chip and cable are heated until the solder reflows and makes the electrical bond Flip chips then normally will undergo an underfill process which will cover the sides of the die, similar to the encapsulation process. The terminology flip chip originates from the upside down (i.e. flipped) mounting of the die. This leaves the chip pads and their solder beads facing down onto the package, while the back side of the die faces up.

This mounting is also known as the Controlled Collapse Chip Connection, or C4.

Flips chips are preferred because of their small size, low mass, and because they can be easily integrated into a cable. Placement on the cable is preferred to integration on the head, primarily because any addition of mass to the head will affect the dynamics as discussed above. The solder bonding technology, though, has a minimum pad pitch of around 200 microns, with a large number of leads in a tape head cable, smaller pitches are preferable if not required. An alternative and preferred method of electrically attaching a flip chip to a cable is to use anisotropic conductive film (ACF) bonding. ACF can be used to couple the chip to a cable, head, etc. In general, ACF includes particles of electrically conductive material embedded in a nonconductive adhesive. Thus, the ACF provides three functions: bonding, conduction in a direction perpendicular to its plane, and insulation in the plane direction.

As shown in FIG. 5, the ACF 500 is placed between the substrate 502 (e.g., diode chip) and component (e.g., cable) 504 to be bonded to the substrate. The substrate/ACF/component stack is then heated and compressed. The particles 506 of electrically conductive material contact the electrically conductive surfaces (e.g., pads) 510, 512 which are located on the substrate and conductive surface 514, 516 which are on the component, providing an electrical connection between the vertically aligned pads (510 with 514 and 512 with 516). Because the particles are isolated in the horizontal plane by the adhesive 508, current does not flow along the horizontal plane, maintaining isolation between horizontally located pads (e.g., 514 is isolated from 512 and 516 while contacting 510). One suitable type of ACF is CP9652KST, sold by Sony Chemical Corporation of America, 1001 Technology Drive, Mount Pleasant, Pa. 15666 USA.

ACF bonding allows use of components with much smaller dimensions than standard gull wing bonding or solder bonding of the chips. With extant ACF bonding techniques for bonding flip chips, the pad separation can be reduced to about 50 micron pitches, and possibly smaller, while gull wing packaged chips using solder bonding are limited to a pitch of about 500 microns and flip chips with solder bonds are limited to a pitch of about 200 microns. As mentioned above, the tape head actuates during use, so any addition of mass to the head affects its dynamics. Thus it is desirable to reduce the mass of the head as much mass as possible. Because flip chips can be made so small and bonded using ACF bonding, the additional mass is negligible and the dynamics of the head are virtually unaffected. Furthermore, because of the small pad pitches achievable with ACF bonding, the flip chip pad pitch can be made to match the lead-to-lead pitch on the cable, simplifying the cable layout and avoiding the need for additional metal layers on a cable and additional metal layers on a cable add substantial cost. The inventor has found ACF bonding to be inexpensive and reliable.

Alternatively, a compression fitting can be used to physically couple the chip to the head or cable. The compression fitting, though is far less desirable due to the added mass of a compression fitting and potential reliability concerns.

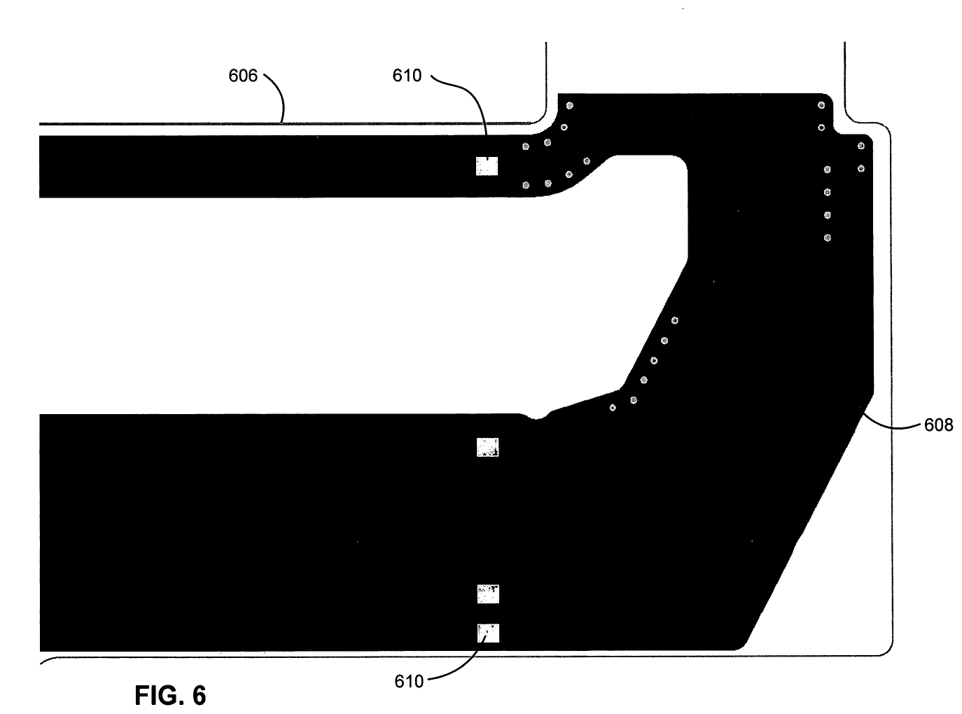

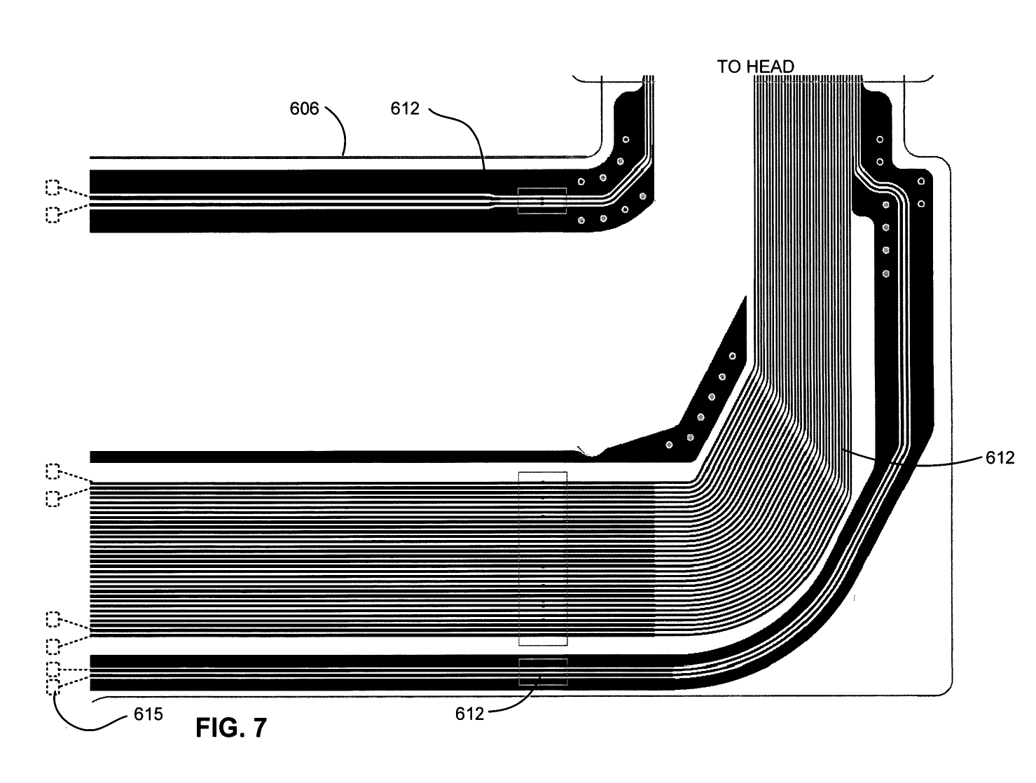

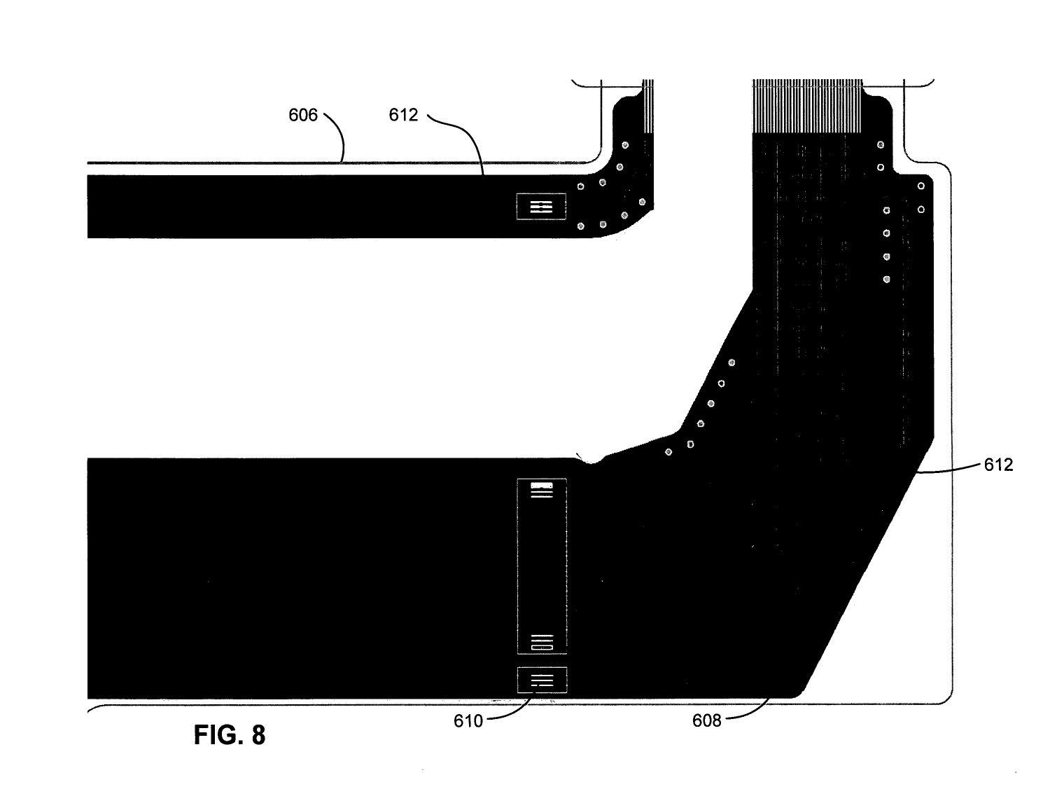

FIGS. 6-9 illustrate coupling of diode chips 600, 602, 604 to a cable 606. FIG. 6 illustrates an under metallized layer 608 of the cable 606. As shown, the under metallized layer 608 has windows 610 formed therein, the importance of which will soon become apparent. FIG. 7 shows the conductive wire traces 612 in the upper metallized layer. The conductive wire traces 612 are typically coupled to the elements of the head (not shown) at one end of the cable, 606 and to pads 615 (a few are shown) at the other end of the cable 606 such as to the head, coupled by thermal compression, ultrasonic bonding, stitch bonding or other standard techniques. FIG. 8 depicts the cable 606 just prior to coupling of the chips 600-604 thereto. The diode chips 600-604 are seated on the cable 606, using optics peering through the windows 610 in the cable 606 to align the pads on the the chips 600-604 properly with the conductive wire traces 612.

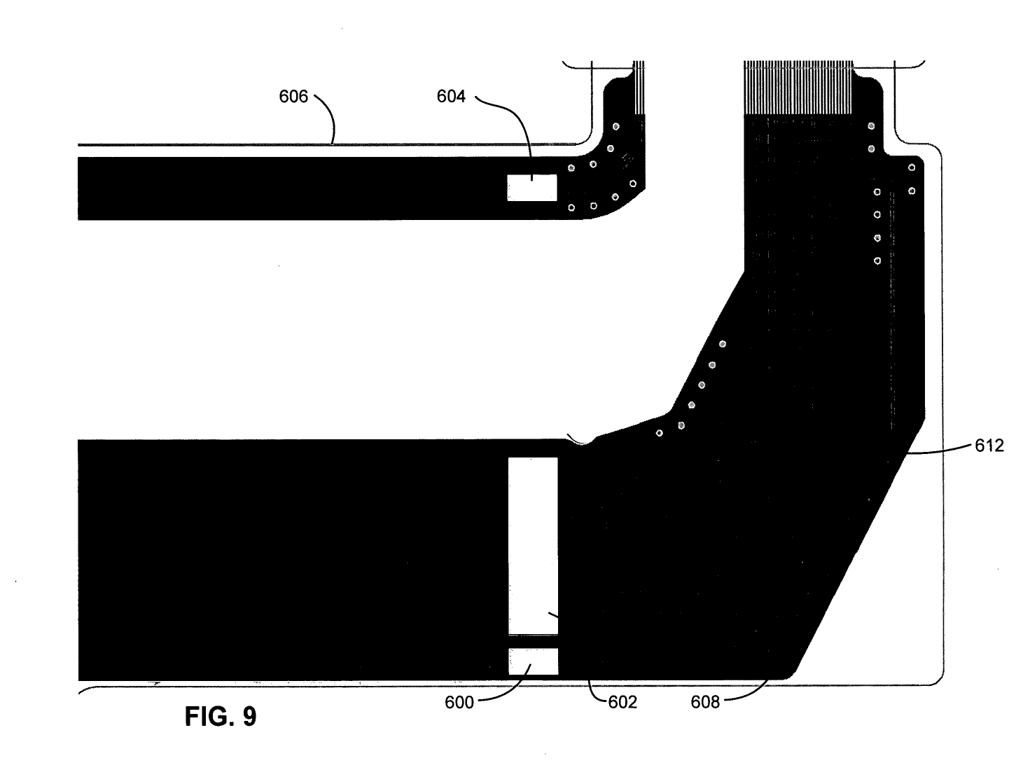

The chips 600-604 are then bonded to the cable 606 and cable wires 612 using ACF bonding, as described above. The upper and lower conductive traces should be attached (deposited onto) an insulative or electrostatic dissipative structure as is commonly known in the cable industry. The insulative layers should separate and encase the conductive wires to give mechanical support and for electrical isolation. An insulative layer (not shown) is then added over at least any portions of the cable 606 having exposed conductors (except where necessary to connect to external devices such as the flip chip, tape head, or drive electronics). For instance, a layer of adhesive can be added, followed by a layer of KAPTON plastic insulative film. The resultant cable is shown in FIG. 9. In this example, single crossed diode chips 600, 604 are bonded across the top two conductors and bottom two conductors. A multiple crossed diode chip 602 is bonded across the middle set of conductors.

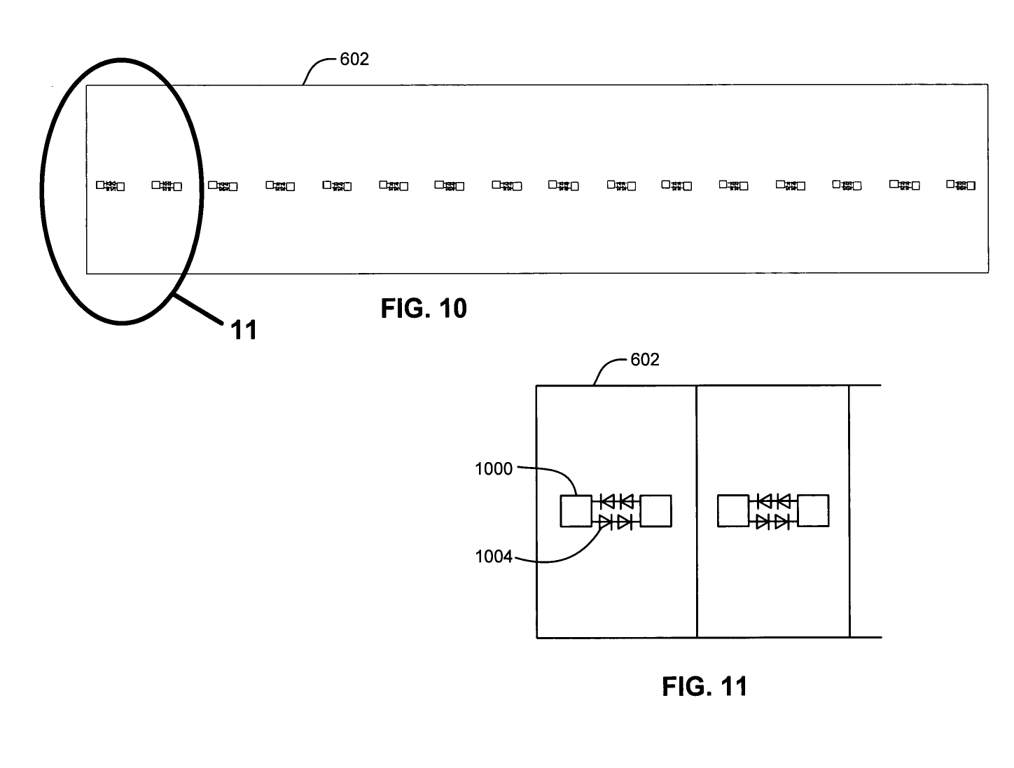

The conductor engaging side of an illustrative multiple crossed diode chip 602 is shown in FIGS. 10-11. As shown, the chip 602 includes contact pads 1000 coupled to the diodes 1004. Illustrative dimensions for the contact pads 1000 are between about 25×25 microns to about 100×100 microns. An illustrative pitch between the centerlines of the contact pads 1000 is between about 50 and 500 microns. The contact pads 1000 are metallized and are preferably raised pads, are coupled to the conductive traces 612 by means such as compression, solder, or ACF. The contact pads 1000 are in electrical communication with the diodes 1004. Except for the diode connection, all pads are electrically isolated fome one another with a high impedance of about 100 to 100,000 ohms or more.

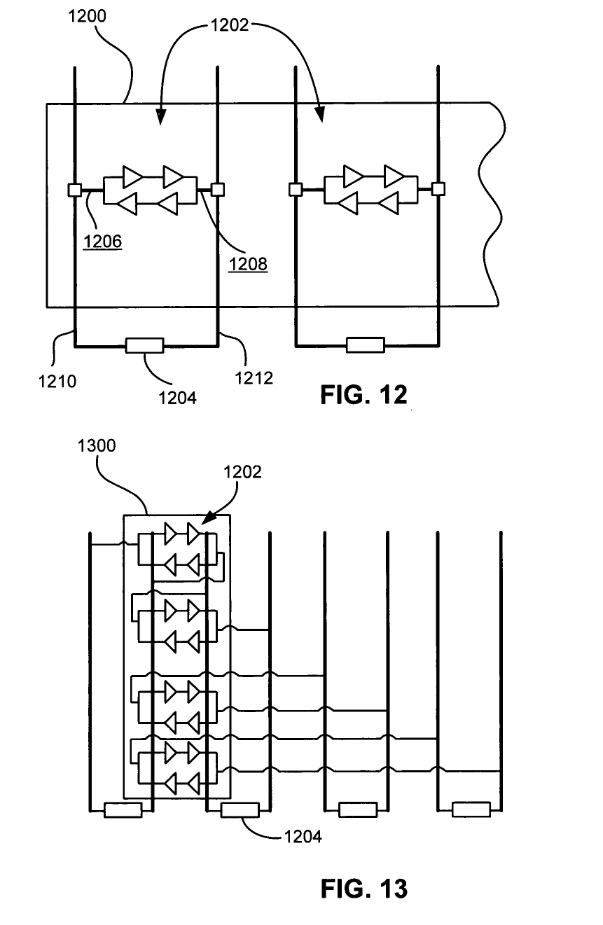

FIGS. 12 and 13 each show different configurations of diode chips 1200, 1300 that can be used as diode chip 602 in FIG. 9. Two alignment orientations of the chip are shown: Horizontal (FIG. 12) and Vertical (FIG. 13), each having their relative advantage or disadvantage and the designer can choose between the two options. Horizontal refers to the pitch of the leads, pads, on the chip and the pitch of the conductive wire traces in the cable being parallel. Vertical refers to the pitch of the leads, pads, on the chip and the pitch of the conductive wire traces in the cable being perpendicular. The chips 1200, 1300 each have a multiplicity of diode sets 1202 used to protect a multiplicity of reader elements 1204. Rₗₑₐₖ is not shown for simplicity. It may or may not be necessary to cross the connections between the chip leads 1206, 1208 and the cable leads 1210, 1212. If the connection and the sensor leads must be crossed, then the connections can be placed on a second layer, as is standard practice in the industry. In the horizontal orientation (FIG. 12), with the proper design of the cable to match the spacing between the leads of the (pitch) leads with those of the chip, the need for a second layer can be avoided, which is especially useful if a metal ground plane already exists in a second layer. If a second layer of metal exists (such as a ground plane), then small sections of the ground plane can be removed so the connections can be made without shorting between unwanted connections. Alternatively, an additional metalization layer can be used for the connecting traces. Additional layers, though, add cost. The vertical alignment might be preferable if the pitch in the chip can not be matched to the pitch of the conductive metal traces in the cable, especially if the former is larger than the latter.

A chip with diodes can be purchased or fabricated using known fabrication techniques. The chip is then attached to the desired object, such as the cable or head. The chip substrate may be flexible, or may be rigid, e.g., a printed circuit board (PCB).

In yet another alternative, the diodes can be formed directly on an object via known methods.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A device for protecting an electronic device from electrostatic discharge (ESD), comprising:
a substrate adapted for coupling to at least one of a multi-element tape drive head and a cable coupled to an electronic device;
multiple sets of crossed diodes coupled to the substrate; and
contact leads coupled to the substrate, the contact leads being in electrical communication with the sets of diodes.

2. A device as recited in claim 1, wherein the substrate is flexible.

3. A device as recited in claim 1, wherein the substrate is substantially resilient.

4. A device as recited in claim 1, wherein each set of crossed diodes includes multiple diodes aligned in series in each direction.

5. A device as recited in claim 4, wherein for each set of crossed diodes the number of diodes in one bias direction is different than a number of diodes in another bias direction.

6. A device as recited in claim 1, wherein the at least one diode has a response time of less than about 20 nanoseconds.

7. A device as recited in claim 1, wherein each set of crossed diodes connects to a ground through a resistor having a leakage resistance.

8. A device as recited in claim 7, wherein the leakage resistance is greater than about 100 ohms.

9. A device as recited in claim 7, wherein the leakage resistance is between about 10,000 ohms and about 1,000,000 ohms.

10. A device as recited in claim 7, where the leakage resistors are deposited on the substrate as an integral component of the substrate.

11. A device as recited in claim 1, wherein the substrate is an electronic chip, wherein the chip is coupled to the tape drive head or the cable.

12. A device as recited in claim 11, wherein the substrate is a flip chip.

13. A device as recited in claim 12, wherein anisotropic conductive film (ACF) is used to couple the flip chip to the head or cable.

14. A device as recited in claim 11, wherein a pitch of the leads or pads in the chip containing the diodes are aligned perpendicularly with respect to the pitch of the leads on the cable.

15. A device as recited in claim 11, wherein a pitch of the leads or pads in the chip containing the diodes are aligned in parallel with the pitch of the leads on the cable.

16. A device as recited in claim 1, wherein the diodes are formed on a chip, wherein the chip is coupled to the substrate.

17. A device as recited in claim 1, further comprising resistive elements in electrical communication with a ground and the sets of diodes.

18. A device as recited in claim 1, wherein each set of crossed diodes is coupled to an individual element of the tape head.

19. A device as recited in claim 1, wherein anisotropic conductive film (ACF) is used to couple at least the coupling region of the substrate to the head or cable.

20. A device as recited in claim 1, wherein a compression fitting is used to couple the substrate to the head or cable.

21. A device for protecting an electronic device from electrostatic discharge (ESD), comprising:
a chip adapted for coupling to a cable;
the chip having multiple sets of crossed diodes, each set of diodes being for providing ESD protection to an individual component of an electronic device coupled to the cable;
the chip having contact leads in electrical communication with the sets of diodes, the electrical leads which can be electrically connected to conductors of the cable.

22. A device as recited in claim 21, wherein anisotropic conductive film (ACF) is used to mechanically and electrically couple the chip to the cable.

23. A device as recited in claim 21, wherein solder is used to electrically couple the chip to the cable with an underflow adhesive to strengthen the mechanical coupling.

24. A device as recited in claim 21, wherein the device is a tape head, wherein the components are selected from a group consisting of data readers, data writers, and servo readers.

25. A tape drive system, comprising:
a magnetic head;
a drive mechanism for passing a magnetic recording tape over the magnetic head;
a controller electrically coupled to the magnetic head for controlling a voltage of the conducting circuit of the magnetic head;
a cable coupling the controller to the magnetic head; and
a diode chip coupled to the cable, the diode chip having multiple sets of crossed diodes, a set of crossed diodes being present for each element of the magnetic head, each pair of crossed diode groups including multiple diodes aligned in series in each direction each set of diodes being for providing ESD protection to an individual component of the magnetic head.
